(19) United States
(12) Patent Application Publication
(10) Pub. No.: US 2012/0046392 A9
(43) Pub. Date: Feb. 23, 2012

(54) Dynamic Copolymers For Workability Retention of Cementitious Composition

(76) Inventors: Klaus Lorenz, Zangberg (DE); Alexander Kraus, Evenhausen (DE); Barbara Wimmer, Tacherting (DE); Petra Wagner, Trostberg (DE); Chiristian Scholz, Wald an der Alz (DE); Christain H+e,uml u+ee bsch, Bad Wiessee (DE); Thomas M. Vickers, JR., Concord Township, OH (US)

(21) Appl. No.: 13/062,278

(22) PCT Filed: Sep. 10, 2009
(86) PCT No.: PCT/EP2009/061728

§ 371 Date: Mar. 15, 2011

Related U.S. Application Data
(60) Provisional application No. 61/096,204, filed on Sep. 11, 2008.

(51) Int. Cl. C04B 24/26

(52) U.S. Cl. 524/5

(57) ABSTRACT

A process for the production of high early strength cementitious compositions includes mixing hydraulic cement, aggregate, water, and a slump retention admixture, wherein the slump retention admixture is a dynamic copolymer containing residues of at least the following monomers: A) a ethylenically unsaturated dicarboxylic acid, B) an ethylenically unsaturated alkenyl ether having an C₂₋₄ oxyalkylene chain of about 1 to 25 units, C) an ethylenically unsaturated alkenyl ether having an C₂₋₄ oxyalkylene chain of 26 to about 300 units, and D) an ethylenically unsaturated monomer comprising a moiety hydrolysable in the cementitious composition, wherein the monomer residue when hydrolyzed comprises an active binding site for a component of the cementitious composition. The present method is useful in the production of precast, ready mix, and/or highly filled cementitious compositions.

Conventional dispersants for cementitious compositions typically achieve good water reduction, however, they are limited in their ability to retain workability over a long period of time. An alternate method for extended workability retention is the use of retarding admixtures. In this scenario, the benefit of workability retention is often achieved at the expense of setting times and early strength. The usefulness of these dispersants is therefore limited by their inherent limitations in molecular architecture.

Conventional dispersants are static in their chemical structure over time in cementitious systems. Their performance is controlled by monomer molar ratio which is fixed within a polymer molecule. A water reducing effect or dispersing effect is observed upon dispersant adsorption onto the cement surface. As dispersant demand increases over time due to abrasion and hydration product formation, which creates more surface area, these conventional dispersants are unable to respond and workability is lost. The subject dynamic polymers are initially lower binding affinity molecules that are essentially “overdosed” relative to the adsorbed amount required to achieve initial workability targets. This excess polymer remains in solution, acting as a reservoir of polymer in solution for future use. Over time, as dispersant demand increases, these molecules undergo base promoted saponification reactions along the polymer backbone which generate additional active binding sites and increase polymer binding affinity.

The use of the subject dynamic polymers as dispersants in cementitious compositions provides extended workability retention beyond what has previously been achievable with static polymers. Typically, the issue of extended workability is solved by either re-tempering (adding more water) to the concrete at the point of placement to restore workability, or by adding more high range water reducer. Addition of water leads to lower strength concrete and thus creates a need for mixes that are “overdesigned” in the way of cement content. Use of the subject dynamic polymers alleviate the need to re-temper, and allow producers to reduce cement content (and thus cost) in their mix designs. Site addition of high range water reducer requires truck mounted dispensers which are costly, difficult to maintain, and difficult to control. Use of dynamic polymers allow for better control over longer term concrete workability, more uniformity and tighter quality control for concrete producers.

Provided is a process for achieving slump retention and also the production of high early strength cementitious compositions utilizing admixtures comprising a polymer composition capable of achieving high early strengths and extended workability.

### BRIEF DESCRIPTION OF THE DRAWINGS

FIG. 1 is a graphical representation of concrete slump versus time comparing the use of the subject dynamic polymer versus a conventional polycarboxylate dispersant in the subject process.

FIG. 2 is a graphical representation of concrete slump versus time comparing the use of the subject dynamic polymer versus a conventional polycarboxylate dispersant in the subject process.

FIG. 3 is a graphical representation of concrete slump versus time comparing the use of the subject dynamic polymer versus a conventional polycarboxylate dispersant in the subject process.

FIG. 4 is a graphical representation of concrete slump versus time comparing the use of the subject dynamic polymer versus a conventional polycarboxylate dispersant in the subject process.

FIG. 5 is a graphical representation of concrete slump-flow versus time comparing the use of the subject dynamic polymer versus a conventional polycarboxylate dispersant in the subject process.

### DETAILED DESCRIPTION

The present process for the production of slump retaining, and high early strength slump retaining cementitious compositions comprises mixing hydraulic cement, aggregate, water, and a slump retention admixture, wherein the slump retention admixture comprises a dynamic polycarboxylate copolymer comprising residues of at least the following monomers,
A) an unsaturated dicarboxylic acid,
B) at least one ethylenically unsaturated alkenyl ether having a C₂₋₄ oxyalkylene chain of about 1 to 25 units,
C) at least one ethylenically unsaturated alkenyl ether having a C₂₋₄ oxyalkylene chain of 26 to about 300 units, and
D) an ethylenically unsaturated monomer comprising a moiety hydrolysable in the cementitious composition, wherein the ethylenically unsaturated monomer residue when hydrolyzed comprises an active binding site for a component of the cementitious composition.
As used herein, the terms “(meth)acrylic” and “(meth)acrylate” are meant to include both acrylic and methacrylic acid and their derivatives. For convenience, reference to any of the constituent monomers herein includes reference to their residue units in the copolymer.

The hydraulic cement can be a portland cement, a calcium aluminate cement, a magnesium phosphate cement, a magnesium potassium phosphate cement, a calcium sulfoaluminate cement, pozzolanic cement, slag cement, or any other suitable hydraulic binder. Aggregate may be included in the cementitious composition. The aggregate can be silica, quartz, sand, crushed marble, glass spheres, granite, limestone, calcite, feldspar, alluvial sands, any other durable aggregate, and mixtures thereof.

The subject dynamic polymers have a portion of their binding sites blocked with groups that are stable to storage and formulation conditions, but these latent binding sites are triggered to be de-protected when the polymer comes into the highly alkaline environment that is found in cementitious compositions.

The dicarboxylic acid (component A) comprises at least one of maleic acid, fumaric acid, itaconic acid, citraconic acid, glutaconic acid, 3-methylglutaconic acid, mesaconic acid, muconic acid, traumatic acid, or salts thereof. Suitable salts include monovalent metal, such as alkali metal, divalent metal, such as alkaline earth metal, ammonium ion, or an organic amine residue. Organic amines may be substituted ammonium groups derived from primary, secondary or tertiary C₁₋₂₀ alkylamines, C₁₋₂₀ alkanolamines, C₅₋₈ cycloalkylamines or C₆₋₁₄ arylamines.

In certain embodiments, at least one of the ethylenically unsaturated alkenyl ethers (component B) and (component C) comprises a C₁₋₈ alkenyl group. In particular embodiments, the alkenyl ether is a vinyl, allyl or (meth)allyl ether, and/or may be derived from a C₂₋₈ unsaturated alcohol. In certain embodiments, the C₂₋₈ unsaturated alcohol is at least one of vinyl alcohol, (meth)allyl alcohol, isoprenol, or methyl butenol.

The ethylenically unsaturated alkenyl ethers further comprise C₂ to C₄ oxyalkylene chains of varying length, that is, varying number of oxyalkylene units. However, a portion of the side chains have a relatively shorter length (lower molecular weight) contributing to improved mass efficiency, and a portion of the side chains have a relatively longer length (higher molecular weight) contributing to higher dispersing effect, higher early strength development, and improved setting times. In certain embodiments, the oxyalkylene units comprise at least one of ethylene oxide, propylene oxide, or combinations thereof. The oxyalkylene units may be present in the form of homopolymers, or random or block copolymers. In particular embodiments, at least one of the alkenyl ether side chains contains at least one C₄ oxyalkylene unit. In certain embodiments, residues of more than one component B type monomer and/or more than one component C type monomer may be present in the subject dynamic polymer molecule.

By way of illustration, but not for limitation, the hydrolysable moiety may comprise at least one of a C₁₋₂₀ alkyl ester, C₁₋₂₀ amino alkyl ester, C₂₋₂₀ alcohol, C₂₋₂₀ amino alcohol, or amide. Hydrolysable moieties may include, but are not limited to, acrylate or methacrylate esters of varied groups having rates of hydrolysis that make them suitable for the time scale of concrete mixing and placement, in certain embodiments up to about 2 to about 4 hours. For example, in one embodiment the ethylenically unsaturated monomer of Component D may include an acrylic acid ester with an ester functionality comprising the hydrolysable moiety. In certain embodiments, the latent binding site may comprise a carboxylic acid ester residue having a hydroxyalkanol hydrolysable moiety or functionality, such as hydroxyethanol or hydroxypropylalcohol. The ester functionality may therefore comprise at least one of hydroxypropyl or hydroxyethyl. In other embodiments, other types of latent binding sites with varying rates of saponification are provided, such as acrylamide or methacrylamide derivatives. In certain embodiments, the ethylenically unsaturated monomer of component D may comprise at least one of an anhydride or imide, optionally comprising at least one of maleic anhydride or maleimide.

Of course, the subject copolymer may comprise the residues of more than one component D ethylenically unsaturated monomer comprising a hydrolysable moiety. For example, more than one component D ethylenically unsaturated monomer comprising a hydrolysable moiety may include the residues of a) more than one type of ethylenically unsaturated monomer; b) more than one hydrolysable moiety; or c) a combination of more than one type of ethylenically unsaturated monomer and more than one hydrolysable moiety. By way of illustration, but not for limitation, the hydrolysable moiety may comprise at least one or more than one C₂₋₂₀ alcohol functionality.

Selection of either or both of the type of ethylenically unsaturated monomer residue unit incorporated into the copolymer chain, and the hydrolysable moiety derivative, or hydrolysable side group, linked to the residue, as well as the type of linkage, affects the rate of hydrolysis of the latent binding site in use, and thus the duration of workability of the cementitious composition comprising the dynamic polymer.

The dynamic polymer may include monomer residues having other linkages such as esters, amides, and the like. For example, the copolymer may additionally include an oxyalkylene side chain substituted monomer residue having at least one linkage of ester, amide, or mixtures thereof. In certain embodiments, the dynamic polymer may include component E monomer residues derived from other non-hydrolysable ethylenically unsaturated monomers, such as styrene, ethylene, propylene, isobutene, alphamethyl styrene, methyl vinyl ether, and the like.

In certain embodiments, the mole ratio of acid monomer (A) to alkenyl ethers (B) and (C), that is, (A):(B+C) is between about 1:2 to about 2:1, in certain embodiments 0.8:1 to about 1.5:1. In certain embodiments the mole ratio of (B):(C) is between about 0.95:0.05 to about 05:0.95. In other embodiments, the mole ratio of (B):(C) is between about 0.85:0.15 to about 0.15:0.85. Also in certain embodiments, the ratio of acid monomer (A) to the monomer comprising a hydrolysable moiety (D) is between about 16:1 to about 1:16, in some embodiments between about 4:1 to about 1:4, in other embodiments between about 3:1 to about 1:3.

In certain embodiments, the dynamic polymer is a copolymer represented by the following general formula I:

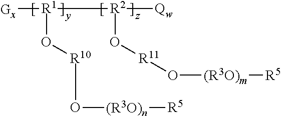

wherein R¹⁰ comprises (CₐH₂ₐ) and a is a numeral from 2 to about 8, wherein mixtures of R¹⁰ are possible in the same polymer molecule; R¹¹ comprises (C_{b}H_{2b}) and b is a numeral from 2 to about 8, wherein mixtures of R¹¹ are possible in the same polymer molecule; R¹ and R² each independently comprise at least one C₂-C₈ linear or branched alkyl; R³ comprises (CHR⁹—CHR⁹)_{c} wherein c=1 to about 3 and R⁹ comprises at least one of H, methyl, ethyl, or phenyl and wherein mixtures of R³ are possible in the same polymer molecule; each R⁵ comprises at least one of H, a C₁₋₂₀ (linear or branched, saturated or unsaturated) aliphatic hydrocarbon radical, a C₅₋₈ cycloaliphatic hydrocarbon radical, or a substituted or unsubstituted C₆₋₁₄ aryl radical; m=1 to 25, n=26 to about 300, w=about 0.125 to about 8 in certain embodiments about 0.5 to about 2, in some embodiments about 0.8 to about 1.5, x=about 0.5 to about 2, in certain embodiments about 0.8 to about 1.5, y=about 0.05 to about 0.95 in certain embodiments about 0.15 to about 0.85, and z=about 0.05 to about 0.95, in certain embodiments 0.15 to about 0.85; y+z=1; each G is represented by at least one of

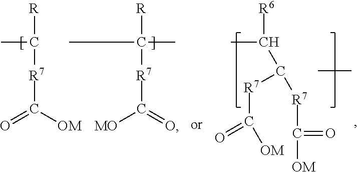

wherein each R independently comprises H or CH₃; each M independently comprises H, a monovalent metal cation such as alkali metal, or (½) divalent metal cation such as alkaline earth metal, an ammonium ion or an organic amine residue; each R⁶ independently comprises at least one of H or C₁₋₃ alkyl; each R⁷ independently comprises a bond, a C₁₋₄ alkylene; and each Q is a component D ethylenically unsaturated monomer comprising a hydrolysable moiety. Examples of the ethylenically unsaturated monomer comprising a hydrolysable moiety are discussed above.

The aryl radical may be substituted by groups such as —CN, —COOR⁸, —R⁸, —OR⁸, hydroxyl, carboxyl or sulfonic acid groups, where R⁸ is hydrogen or a C₁₋₂₀ aliphatic hydrocarbon radical. In certain embodiments, the amide may be —NH—R⁵, where R⁵ is as defined above.

In certain embodiments, the component D ethylenically unsaturated monomer comprising a hydrolysable moiety is represented by formula II:

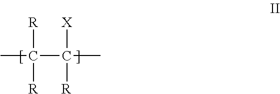

wherein each R independently comprises H or CH₃; and X comprises a hydrolysable moiety. In certain embodiments, the hydrolysable moiety comprises at least one of alkyl ester, amino alkyl ester, hydroxyalkyl ester, amino hydroxyalkyl ester, or amide such as acrylamide, methacrylamide and their derivatives.

In certain embodiments, the component D ethylenically unsaturated monomer comprising a hydrolysable moiety is represented by formula III:

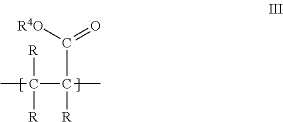

wherein each R independently comprises at least one of H or CH₃; and R⁴ comprises at least one of C₁₋₂₀ alkyl or C₂₋₂₀ hydroxyalkyl.

The subject dynamic polymers can be prepared by known art methods, including copolymerizing substituted monomers, copolymerizing unsubstituted monomers followed by derivatizing the polymer backbone, or by combinations of these methods.

The dynamic copolymer may be prepared by batch, semi-batch, semi-continuous or continuous procedures, including introduction of components during initiation of polymerization, by linear dosage techniques, or by ramp-wise dosage techniques with changes in dosage stepwise or continuously, both to higher and/or lower dosage rates in comparison to the previous rate.

Examples of ethylenically unsaturated monomers capable of forming monomer residues comprising Components B and/or C that can be copolymerized, whether hydrolysable or non-hydrolysable, include vinyl alcohol derivatives such as polyethylene glycol mono(meth)vinyl ether, polypropylene glycol mono(meth)vinyl ether, polybutylene glycol mono(meth)vinyl ether, polyethylene glycol polypropylene glycol mono(meth)vinyl ether, polyethylene glycol polybutylene glycol mono(meth)vinyl ether, polypropylene glycol polybutylene glycol mono(meth)vinyl ether, polyethylene glycol polypropylene glycol polybutylene glycol mono(meth)vinyl ether, methoxypolyethylene glycol mono(meth)vinyl ether, methoxypolypropylene glycol mono(meth)vinyl ether, methoxypolybutylene glycol mono(meth)vinyl ether, methoxypolyethylene glycol polypropylene glycol mono(meth)vinyl ether, methoxypolyethylene glycol polybutylene glycol mono(meth)vinyl ether, methoxypolypropylene glycol polybutylene glycol mono(meth)vinyl ether, methoxypolyethylene glycol polypropylene glycol polybutylene glycol mono(meth)vinyl ether, ethoxypolyethylene glycol mono(meth)vinyl ether, ethoxypolypropylene glycol mono(meth)vinyl ether, ethoxypolybutylene glycol mono(meth)vinyl ether, ethoxypolyethylene glycol polypropylene glycol mono(meth)vinyl ether, ethoxypolyethylene glycol polybutylene glycol mono(meth)vinyl ether, ethoxypolypropylene glycol polybutylene glycol mono(meth)vinyl ether, ethoxypolyethylene glycol polypropylene glycol polybutylene glycol mono(meth)vinyl ether, and the like;

(meth)allyl alcohol derivatives such as polyethylene glycol mono(meth)allyl ether, polypropylene glycol mono(meth)allyl ether, polybutylene glycol mono(meth)allyl ether, polyethylene glycol polypropylene glycol mono(meth)allylether, polyethylene glycol polybutylene glycol mono(meth)allyl ether, polypropylene glycol polybutylene glycol mono(meth)allyl ether, polyethylene glycol polypropylene glycol polybutylene glycol mono(meth)allyl ether, methoxypolyethylene glycol mono(meth)allyl ether, methoxypolypropylene glycol mono(meth)allyl ether, methoxypolybutylene glycol mono(meth)allyl ether, methoxypolyethylene glycol polypropylene glycol mono(meth)allyl ether, methoxypolyethylene glycol polybutylene glycol mono(meth)allyl ether, methoxypolypropylene glycol polybutylene glycol mono(meth)allyl ether, methoxypolyethylene glycol polypropylene glycol polybutylene glycol mono(meth)allyl ether, ethoxypolyethylene glycol mono(meth)allylether, ethoxypolypropylene glycol mono(meth)allyl ether, ethoxypolybutylene glycol mono(meth)allyl ether, ethoxypolyethylene glycol polypropylene glycol mono(meth)allyl ether, ethoxypolyethylene glycol polybutylene glycol mono(meth)allyl ether, ethoxypolypropylene glycol polybutylene glycol mono(meth)allyl ether, ethoxypolyethylene glycol polypropylene glycol polybutylene glycol mono(meth)allyl ether, and the like;
adducts of 1 to 350 moles of alkylene oxide with an unsaturated alcohol such as 3-methyl-3-buten-1-ol, 3-methyl-2-buten-1-ol, 2-methyl-3-buten-2-ol, 2-methyl-2-buten-1-ol, and 2-methyl-3-buten-1-ol, either alone respectively or in combinations with each other, including but not limited to polyethylene glycol mono (3-methyl-3-butenyl)ether, polyethylene glycol mono (3-methyl-2-butenyl)ether, polyethylene glycol mono (2-methyl-3-butenyl)ether, polyethylene glycol mono (2-methyl-2-butenyl)ether, polyethylene glycol mono (1,1-dimethyl-2-propenyl)ether, polyethylene polypropylene glycol mono (3-methyl-3-butenyl)ether, polypropylene glycol mono (3-methyl-3-butenyl)ether, methoxypolyethylene glycol mono (3-methyl-3-butenyl)ether, ethoxypolyethylene glycol mono (3-methyl-3-butenyl)ether, 1-propoxypolyethylene glycol mono (3-methyl-3-butenyl)ether, cyclohexyloxypolyethylene glycol mono (3-methyl-3-butenyl)ether, 1-ocyloxypolyethylene glycol mono (3-methyl-3-butenyl)ether, nonylalkoxypolyethylene glycol mono (3-methyl-3-butenyl)ether, laurylalkoxypolyethylene glycol mono (3-methyl-3-butenyl)ether, stearylalkoxypolyethylene glycol mono (3-methyl-3-butenyl)ether, and phenoxypolyethylene glycol mono (3-methyl-3-butenyl)ether, and the like.

Examples of ethylenically unsaturated monomers capable of forming hydrolysable monomer residues comprising Component D that can be copolymerized include but are not limited to unsaturated monocarboxylic acid ester derivatives such as alkyl acrylates such as methyl acrylate, ethyl acrylate, propyl acrylate, and butyl acrylate; alkyl methacrylates such as methyl methacrylate, ethyl methacrylate, propyl methacrylate, and butyl methacrylate; hydroxyalkyl acrylates such as hydroxyethyl acrylate, hydroxypropyl acrylate, and hydroxybutyl acrylate; hydroxyalkyl methacrylates such as hydroxyethyl methacrylate, hydroxypropyl methacrylate, and hydroxybutyl methacrylate; acrylamide, methacrylamide, and derivatives thereof; maleic acid alkyl or hydroxyalkyl mono- or di-esters; and maleic anhydride or maleimide for copolymers to be stored in the dry phase.

The subject dynamic copolymer may have a weight average molecular weight (MW) of about 5,000 to about 150,000, in certain embodiments about 10,000 to about 50,000.

The subject dynamic copolymer admixture can be added to the cementitious mixture with the initial batch water or as a delayed addition, in a dosage range of about 0.01 to about 2 percent active polymer based on the weight of cementitious materials, in certain embodiments, 0.05 to 1 weight percent active polymer.

The present process utilizing the subject dynamic copolymers may be used in ready mix or pre-cast applications to provide differentiable workability retention and all of the benefits associated therewith. Suitable applications include flatwork, paving (which is typically difficult to air entrain by conventional means), vertical applications, and precast articles. Further, the subject dynamic copolymers have shown particular value in workability retention of highly filled cementitious mixtures such as those containing large amounts of inert fillers, including but not limited to limestone powder. By “highly filled” is meant that the fillers, discussed in more detail below, comprise greater than about 10 weight percent, based on the weight of cementitious material (hydraulic cement).

The cementitious compositions described herein may contain other additives or ingredients and should not be limited to the stated or exemplified formulations. Cement admixtures or additives that can be added independently include, but are not limited to: air entrainers, aggregates, pozzolans, other fillers, dispersants, set and strength accelerators/enhancers, set retarders, water reducers, corrosion inhibitors, wetting agents, water soluble polymers, rheology modifying agents, water repellents, fibers, damp-proofing admixtures, permeability reducers, pumping aids, fungicidal admixtures, germicidal admixtures, insecticide admixtures, finely divided mineral admixtures, alkali-reactivity reducer, bonding admixtures, shrinkage reducing admixtures, and any other admixture or additive that does not adversely affect the properties of the cementitious composition. The cementitious compositions need not contain one of each of the foregoing admixtures or additives.

Aggregate can be included in the cementitious formulation to provide for mortars which include fine aggregate, and concretes which also include coarse aggregate. The fine aggregates are materials that almost entirely pass through a Number 4 sieve (ASTM C125 and ASTM C33), such as silica sand. The coarse aggregates are materials that are predominantly retained on a Number 4 sieve (ASTM C125 and ASTM C33), such as silica, quartz, crushed marble, glass spheres, granite, limestone, calcite, feldspar, alluvial sands, sands or any other durable aggregate, and mixtures thereof.

Fillers for cementitious compositions may include aggregate, sand, stone, gravel, pozzolan, finely divided minerals, such as raw quartz, limestone powder, fibers, and the like, depending upon the intended application. As non-limiting examples, stone can include river rock, limestone, granite, sandstone, brownstone, conglomerate, calcite, dolomite, marble, serpentine, travertine, slate, bluestone, gneiss, quartzitic sandstone, quartzite and combinations thereof.

A pozzolan is a siliceous or aluminosiliceous material that possesses little or no cementitious value but will, in the presence of water and in finely divided form, chemically react with the calcium hydroxide produced during the hydration of portland cement to form materials with cementitious properties. Diatomaceous earth, opaline cherts, clays, shales, fly ash, slag, silica fume, volcanic tuffs and pumicites are some of the known pozzolans. Certain ground granulated blast-furnace slags and high calcium fly ashes possess both pozzolanic and cementitious properties. Natural pozzolan is a term of art used to define the pozzolans that occur in nature, such as volcanic tuffs, pumices, trasses, diatomaceous earths, opaline, cherts, and some shales. Fly ash is defined in ASTM C618.

If used, silica fume can be uncompacted or can be partially compacted or added as a slurry. Silica fume additionally reacts with the hydration byproducts of the cement binder, which provides for increased strength of the finished articles and decreases the permeability of the finished articles. The silica fume, or other pozzolans such as fly ash or calcined clay such as metakaolin, can be added to the cementitious mixture in an amount from about 5% to about 70% based on the weight of cementitious material.

The present process is useful in the production of precast, ready mix, and/or highly filled cementitious compositions.

### Precast Cementitious Compositions:

The term “precast” cementitious compositions or precast concrete refers to a manufacturing process in which a hydraulic cementitious binder, such as Portland cement, and aggregates, such as fine and course sand, are placed into a mold and removed after curing, such that the unit is manufactured before delivery to a construction site.

Precast applications include, but are not limited to, precast cementitious members or parts such as beams, double-Ts, pipes, insulated walls, prestressed concrete products, and other products where the cementitious composition is poured directly into forms and final parts are transported to job sites.

The production of precast cementitious members usually involves the incorporation of steel reinforcement. The reinforcement may be present as structural reinforcement due to the designed use of the member in which it is included, or the steel may simply be present to allow for a member (such as a curtain wall panel) to be stripped from its mold without cracking.

As used herein, “pre-stressed” concrete refers to concrete whose ability to withstand tensile forces has been improved by using prestressing tendons (such as steel cable or rods), which are used to provide a clamping load producing a compressive strength that offsets the tensile stress that the concrete member would otherwise experience due to a bending load. Any suitable method known in the art can be used to pre-stress concrete. Suitable methods include, but are not limited to pre-tensioned concrete, where concrete is cast around already tensioned tendons, and post-tensioned concrete, where compression is applied to the concrete member after the pouring and curing processes are completed.

In certain precast applications, it is desired that the cementitious composition mixture have sufficient fluidity that it flows through and around the reinforcement structure, if any, to fill out the mold and level-off at the top of the mold and consolidates without the use of vibration. This technology is commonly referred to as self-consolidating concrete (SCC). In other embodiments, the mold may need to be agitated to facilitate the levelling-off of the mixture, such as by vibration molding and centrifugal molding. In addition to the requirement for workability retention, there is a requirement for the cementitious composition to achieve fast setting times and high early strength.

With respect to precast applications, the term “high early strength” refers to the compressive strength of the cementitious mass within a given time period after pouring into the mold. Therefore, it is desirable that the cementitious composition mixture has initial fluidity and maintains fluidity until placement, but also has high early strength before and by the time that the precast concrete units are to be removed from the mold.

High early-strength reinforced pre-cast or cast in place cementitious members produced without metal bar, metal fiber or metal rod reinforcement that comprise hydraulic cement, polycarboxylate dispersant, and structural synthetic fibers are disclosed in commonly owned U.S. Pat. No. 6,942,727, incorporated herein by reference.

To achieve the high strengths of precast cementitious compositions, very low water to cement ratios are used. This necessitates a significant amount of high-range water reducer (HRWR) to produce a workable mixture. Traditional HRWR chemistry such as naphthalene sulfonate formaldehyde condensates will potentially retard set at such high dosages, and thereby inhibit the development of the high early strength necessary for stripping the member from the mold.

Typically early-strength development refers to compressive strengths being achieved in 12-18 hours after placing the unset cementitious composition in the mold.

To achieve a rapid level of strength development in the formation of pre-cast cementitious members without an external heat source, traditional dispersant chemistries would not be successful because of their excessive retarding effect on cement hydration.

In precast applications, the water to cement ratio is typically above about 0.2 but less than or equal to about 0.45.

A process is provided for making cast in place and pre-cast cementitious members. The method comprises mixing a cementitious composition comprising hydraulic cement, such as portland cement, and the above described dynamic copolymer dispersant with water, and optionally coarse aggregate, fine aggregate, structural synthetic fibers, or other additives, such as additives to control excessive shrinkage and/or alkali-silica reaction, then forming the member from the mixture. Forming can be any conventional method, including placing the mixture in a mold to set or cure and stripping away mold.

The precast cementitious members or articles formed by the above process can be used in any application but are useful for architectural, structural and non-structural applications. As examples but not by way of limitation, the precast articles can be formed as wall panels, beams, columns, pipes, manholes (inclined walls), segments, precast plates, box culverts, pontoons, double-Ts, U-tubes, L-type retaining walls, beams, cross beams, road or bridge parts and various blocks or the like. However, the precast concrete articles are not limited to such specific examples.

### Ready Mix and Highly Filled Cementitious Compositions:

As used herein, the term “ready mix” refers to cementitious composition that is batch mixed or “batched” for delivery from a central plant instead of being mixed on a job site. Typically, ready mix concrete is tailor-made according to the specifics of a particular construction project and delivered ideally in the required workability in “ready mix concrete trucks”.

Over the years, the use of fillers and/or pozzolanic materials as a partial replacement for portland cement in concrete has become an increasingly attractive alternative to portland cement alone. The desire to increase the use of inert fillers and/or fly ash, blast furnace slag, and natural pozzolanic cement in concrete mixtures can be attributed to several factors. These include cement shortages, economic advantages of portland cement replacement, improvements in permeability of the concrete product, and lower heats of hydration.

Despite the cost and performance advantages of using inert or pozzolanic materials as partial replacements of portland cement in concrete, there are practical limitations to the amount at which they can be used in the cementitious mixture. Using these materials at higher levels, such as above about 10 weight percent based on the weight of the portland cement, can result in the retarded setting time of the concrete up to several hours, and perhaps longer depending upon the ambient temperature. This incompatibility puts a burden of increased costs and time on the end user, which is unacceptable.

While it is known to use set time accelerators in concrete mixtures, these accelerator admixtures have been problematic, particularly when used with water reducing admixtures, so that set time cannot be decreased to an acceptable level. The use of accelerators with water reducers, such as naphthalene sulfonate formaldehyde condensates, lignin and substituted lignins, sulfonated melamine formaldehyde condensates and the like, has been ineffective to produce an acceptable highly filled or pozzolanic replacement containing hydraulic cement based cementitious mixture with normal setting characteristics and an acceptable resulting concrete.

The subject dynamic copolymers in cementitious compositions, alone or in combination with another water reducing composition such as a traditional dispersant or a conventional polycarboxylate dispersant, exhibit superior workability retention without retardation, minimize the need for slump adjustment during production and at the jobsite, minimize mixture over-design requirements, reduce re-dosing of high-range water-reducers at the jobsite, and provide high flowability and increased stability and durability.

Slump is a measure of the consistency of concrete, and is a simple means of ensuring uniformity of concrete on-site. To determine slump, a standard size slump cone is filled with fresh concrete. The cone is then removed, and the “slump” is the measured difference between the height of the cone and the collapsed concrete immediately after removal of the slump cone.

The subject process may therefore also comprise adding to the cementitious mixture an additional water reducing composition as a component of the dynamic copolymer admixture or separately. The water reducing composition may comprise at least one of traditional water reducers, conventional polycarboxylate dispersants, polyaspartate dispersants, or oligomeric dispersants.

By way of illustration but not limitation, the traditional water reducer may comprise at least one of lignosulfonates, melamine sulfonate resins, sulfonated melamine formaldehyde condensates, or salts of sulfonated melamine sulfonate condensates.

Conventional polycarboxylate dispersants typically comprise copolymers of carboxylic acid, derivatized carboxylic acid esters, and/or derivatized alkenyl ethers. The derivatives, or side chains, are generally long (greater than about 500 MW) and are not readily hydrolysable from the polymer backbone in cementitious compositions.

By way of illustration but not limitation, examples of polycarboxylate dispersants can be found in U.S. Publication No. 2008/0300343 A1, U.S. Publication No. 2002/0019459 A1, U.S. Publication No. 2006/0247402 A1, U.S. Pat. No. 6,267,814, U.S. Pat. No. 6,290,770, U.S. Pat. No. 6,310,143, U.S. Pat. No. 6,187,841, U.S. Pat. No. 5,158,996, U.S. Pat. No. 6,008,275, U.S. Pat. No. 6,136,950, U.S. Pat. No. 6,284,867, U.S. Pat. No. 5,609,681, U.S. Pat. No. 5,494,516, U.S. Pat. No. 5,674,929, U.S. Pat. No. 5,660,626, U.S. Pat. No. 5,668,195, U.S. Pat. No. 5,661,206, U.S. Pat. No. 5,358,566, U.S. Pat. No. 5,162,402, U.S. Pat. No. 5,798,425, U.S. Pat. No. 5,612,396, U.S. Pat. No. 6,063,184, U.S. Pat. No. 5,912,284, U.S. Pat. No. 5,840,114, U.S. Pat. No. 5,753,744, U.S. Pat. No. 5,728,207, U.S. Pat. No. 5,725,657, U.S. Pat. No. 5,703,174, U.S. Pat. No. 5,665,158, U.S. Pat. No. 5,643,978, U.S. Pat. No. 5,633,298, U.S. Pat. No. 5,583,183, U.S. Pat. No. 6,777,517, U.S. Pat. No. 6,762,220, U.S. Pat. No. 5,798,425, and U.S. Pat. No. 5,393,343, which are all incorporated herein by reference, as if fully written out below.

By way of illustration but not limitation, examples of polyaspartate dispersants can be found in U.S. Pat. No. 6,429,266; U.S. Pat. No. 6,284,867; U.S. Pat. No. 6,136,950; and U.S. Pat. No. 5,908,885, which are all incorporated herein by reference, as if fully written out below.

By way of illustration but not limitation, examples of oligomeric dispersants can be found in U.S. Pat. No. 6,133,347; U.S. Pat. No. 6,451,881; U.S. Pat. No. 6,492,461; U.S. Pat. No. 6,861,459; and U.S. Pat. No. 6,908,955, which are all incorporated herein by reference, as if fully written out below.

When used in combination with a traditional water reducing dispersant or a conventional polycarboxylate, polyaspartate, or oligomeric dispersant in order to provide desired initial slump and to tailor workability of a cementitious mixture for a specific application, the subject dynamic copolymer can be added to the cementitious mixture with the initial batch water or as a delayed addition, in a dosage range of about 0.01 to about 1 weight percent dynamic copolymer based on the weight of cementitious materials, and in certain embodiments, about 0.02 to about 0.5 weight percent copolymer, and the traditional water reducing dispersant or conventional dispersant can be added to the cementitious mixture with the initial batch water or as a delayed addition to the cementitious mixture, in a dosage range of about 0.01 to about 1 weight percent dispersant based on the weight of cementitious materials, and in certain embodiments, about 0.02 to about 0.5 weight percent dispersant.

### EXAMPLES

Specific embodiments of dynamic copolymers were tested according to the examples set forth below, and compared with conventional “static” polycarboxylate dispersants.

### Synthesis Example A

A glass reactor equipped with multiple necks, a mechanical stirrer, pH-meter and dosing equipment (e.g. syringe pump) was charged with 420 g of water, 172 g of molten vinyl-PEG 1100 and 255 g of molten vinyl-PEG 5800 (solution A). The temperature in the reactor was adjusted to 13° C.

A portion (74.8 g) of a previously prepared second solution (solution B), consisting of 151.2 g water, 19.6 g maleic anhydride, 31.2 g KOH (40%) and 32.5 g of hydroxypropyl acrylate (HPA, 96%) was added to the reactor vessel drop wise over a period of 10 minutes under moderate stirring. A pH of 5.8 was adjusted for the resulting solution in the reactor by addition of 3.6 g H₂SO₄ (20%). To the remaining solution B was added 3.69 g 3-mercaptopropionic acid (3-MPA). A further amount of 0.92 g 3-MPA was added to the reactor shortly before initiation of polymerization. A third solution, (solution C) containing 3 g of sodium hydroxymethane sulfinate dihydrate in 47 g water was prepared.

The polymerization was initiated by adding 32 mg FeSO₄×7H₂O that was dissolved in several milliliters of water and 3 g of H₂O₂ (30%) solution to the reaction vessel. Simultaneously, the dosing of solution B and C into the polymerization vessel was started. Solution B was dosed over a period of 30 minutes using varying addition rates as described in the table below. Solution C was dosed at a constant speed of 30 g/h over a period of 30 minutes followed by a higher dosing speed of 75 g/h over an additional 25 minutes. During the 30 minute dosing period of solution B, the pH in the reactor was maintained at 5.8 by adding 5 g 40% aqueous KOH solution. The pH of the polymer solution after the addition of solution C was adjusted to pH to 7 with 8.9 g KOH solution. (40%). An aqueous solution of the dynamic copolymer comprising the copolymerized residues of maleic acid, and two alkenyl polyethyleneoxide ethers with a yield of 95%, a weight-average molecular weight of 31,000 g/mole, a polydispersity index (PDI) of 1.47 as determined by SEC and a solids content of 44.1% was obtained.

Ramp Table A

| t (min) | 0 | 2 | 4 | 8 | 10 | 12 | 14 | 16 | 18 | 22 | 26 | 30 |
|---|---|---|---|---|---|---|---|---|---|---|---|---|
| g/h | 450 | 498 | 521 | 609 | 450 | 367 | 302 | 241 | 187 | 115 | 71 | 0 |

### Examples 1-10

Sample cementitious compositions were prepared by mixing cement, sand, stone and water in a rotating drum mixer, with the additives present, in the amounts listed in Tables 1A and 1B. Examples 1-5 included the subject dynamic copolymer admixture comprising the dynamic copolymer of Example A, while Comparative Examples 6-10 included a conventional polycarboxylate dispersant.

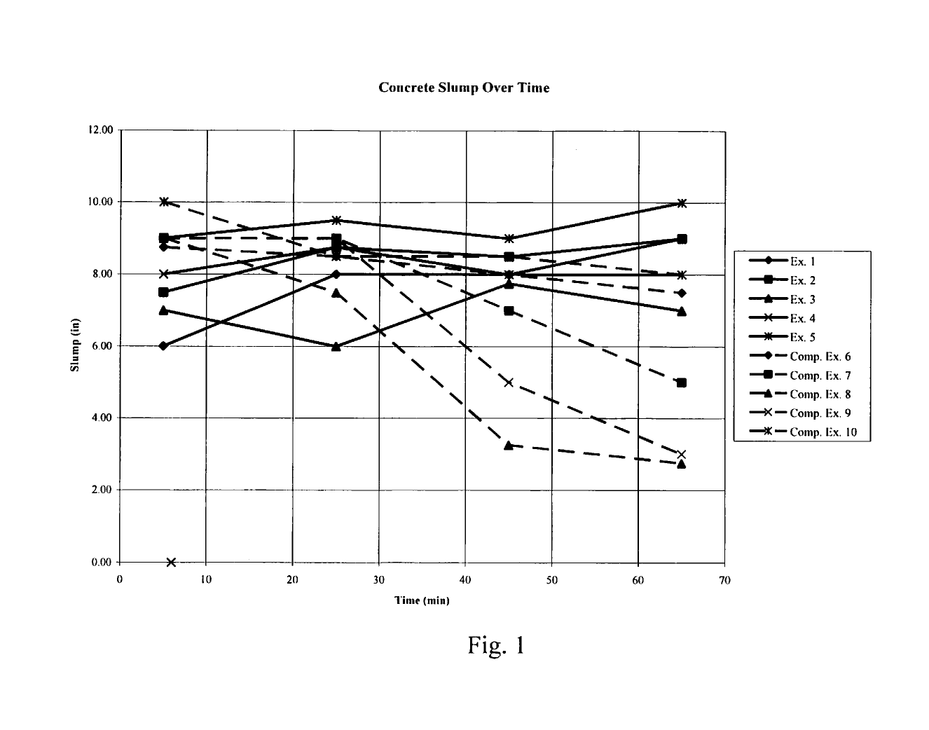

The slump, which is also a measure of workability, was determined according to ASTM C143. The air content (ASTM C231), set time (ASTM C403), and compressive strength (ASTM C39) of each composition were also determined, reported in Tables 1A and 1B. As shown in Tables 1A and 1B and FIG. 1, the subject dynamic copolymer used in Examples 1-5 maintains the workability of the cementitious composition longer than the polymers utilized in Comparative Examples 6-10, while not significantly affecting air content, set time, or compressive strength.

TABLE 1A

| | Ex. 1 | | Ex. 2 | | Ex. 3 | | Ex. 4 | | Ex. 5 | |
|---|---|---|---|---|---|---|---|---|---|---|
| Dispersant | Dynamic | | Dynamic | | Dynamic | | Dynamic | | Dynamic | |
| | Copolymer | | Copolymer | | Copolymer | | Copolymer | | Copolymer | |
| Dose (% cmt) | 0.280 | | 0.260 | | 0.270 | | 0.210 | | 0.220 | |
| Cement | Essroc | | Lehigh | | Lafarge | | Holcim I/II | | Ash Grove | |
| | Nazareth | | Evansville | | Whitehall | | | | TX | |
| Dose (% cmt) | 0.004 | | 0.004 | | 0.004 | | 0.004 | | 0.004 | |
| Defoamer | TBP | | TBP | | TBP | | TBP | | TBP | |
| Cement kg/m³ | 444 | (749) | 444 | (749) | 445 | (750) | 447 | (753) | 451 | (760) |
| (lbs/yd³) | | | | | | | | | | |
| Sand kg/m³ | 705 | (1188) | 705 | (1188) | 706 | (1189) | 709 | (1194) | 715 | (1205) |
| (lbs/yd³) | | | | | | | | | | |
| Stone kg/m³ | 1073 | (1809) | 1073 | (1808) | 1074 | (1810) | 1079 | (1818) | 1089 | (1835) |
| (lbs/yd³) | | | | | | | | | | |
| Water kg/m³ | 160 | (270) | 158 | (266) | 160 | (270) | 158 | (266) | 154 | (260) |
| (lbs/yd³) | | | | | | | | | | |

Slump cm (in)

| | | | | | | | | | | |
|---|---|---|---|---|---|---|---|---|---|---|
| Initial | 15.2 | (6.00) | 19.1 | (7.50) | 17.9 | (7.00) | 20.3 | (8.00) | 22.9 | (9.00) |
| 25 min. | 20.3 | (8.00) | 22.2 | (8.75) | 15.2 | (6.00) | 22.2 | (8.75) | 24.1 | (9.50) |
| 45 min. | 20.3 | (8.00) | 21.6 | (8.50) | 19.7 | (7.75) | 20.3 | (8.00) | 22.9 | (9.00) |
| 65 min. | 22.9 | (9.00) | 22.9 | (9.00) | 17.9 | (7.00) | 20.3 | (8.00) | 25.4 | (10.00) |

Air Content (%)

| | | | | | |
|---|---|---|---|---|---|
| Initial | 2.1 | 2.3 | 2.0 | 1.9 | 1.5 |
| 65 min. | 2.0 | 1.7 | 2.2 | 1.8 | 0.8 |
| Initial Set (hrs) | 7.9 | 7.5 | 6.4 | 5.0 | 5.6 |
| Final Set (hrs) | 9.2 | 8.7 | 7.7 | 6.0 | 7.0 |

Compressive Strength N/mm² (psi)

| | | | | | | | | | | |
|---|---|---|---|---|---|---|---|---|---|---|
| 1 day | 32.96 | (4780) | 31.51 | (4570) | 36.47 | (5290) | 33.92 | (4920) | 29.44 | (4270) |
| 7 days | 52.88 | (7670) | 50.61 | (7340) | 47.85 | (6940) | 51.99 | (7540) | 53.99 | (7830) |
| 28 days | 57.99 | (8410) | 58.47 | (8480) | 55.09 | (7990) | 59.23 | (8590) | 65.99 | (9570) |

TBP = tributyl phosphate

TABLE 1B

| | Comp. Ex. 6 | | Comp. Ex. 7 | | Comp. Ex. 8 | | Comp. Ex. 9 | | Comp. Ex. 10 | |
|---|---|---|---|---|---|---|---|---|---|---|
| Dispersant | Conventional | | Conventional | | Conventional | | Conventional | | Conventional | |
| | Poly- | | Poly- | | Poly- | | Poly- | | Poly- | |
| | carboxylate | | carboxylate | | carboxylate | | carboxylate | | carboxylate | |
| Dose (% cmt) | 0.120 | | 0.120 | | 0.120 | | 0.120 | | 0.120 | |
| Cement | Essroc | | Lehigh | | Lafarge | | Holcim I/II | | Ash Grove | |
| | Nazareth | | Evansville | | Whitehall | | | | TX | |
| Dose (% cmt) | 0.004 | | 0.004 | | 0.004 | | 0.004 | | 0.004 | |
| Defoamer | TBP | | TBP | | TBP | | TBP | | TBP | |
| Cement kg/m³ | 446 | (751) | 443 | (747) | 446 | (751) | 447 | (754) | 452 | (761) |
| (lbs/yd³) | | | | | | | | | | |
| Sand kg/m³ | 707 | (1191) | 703 | (1184) | 707 | (1191) | 709 | (1195) | 716 | (1206) |
| (lbs/yd³) | | | | | | | | | | |
| Stone kg/m³ | 1077 | (1814) | 1070 | (1803) | 1077 | (1814) | 1080 | (1820) | 1090 | (1837) |
| (lbs/yd³) | | | | | | | | | | |
| Water kg/m³ | 161 | (271) | 158 | (266) | 161 | (271) | 158 | (266) | 154 | (260) |
| (lbs/yd³) | | | | | | | | | | |

Slump cm (in)

| | | | | | | | | | | |
|---|---|---|---|---|---|---|---|---|---|---|
| Initial | 22.2 | (8.75) | 22.9 | (9.00) | 22.9 | (9.00) | 22.9 | (9.00) | 25.4 | (10.00) |
| 25 min. | 21.6 | (8.50) | 22.9 | (9.00) | 19.1 | (7.50) | 22.9 | (9.00) | 21.6 | (8.50) |
| 45 min. | 20.3 | (8.00) | 17.9 | (7.00) | 8.26 | (3.25) | 12.7 | (5.00) | 21.6 | (8.50) |
| 65 min. | 19.1 | (7.50) | 12.7 | (5.00) | 6.99 | (2.75) | 7.62 | (3.00) | 20.3 | (8.00) |

Air Content (%)

| | | | | | |
|---|---|---|---|---|---|
| Initial | 1.8 | 2.6 | 1.8 | 1.8 | 1.4 |
| 65 min. | 2.1 | 2.2 | 2.1 | 2.2 | 1.8 |
| Initial Set (hrs) | 6.1 | 5.7 | 4.7 | 4.1 | 4.6 |
| Final Set (hrs) | 7.5 | 7.0 | 6.0 | 5.2 | 5.9 |

Compressive Strength N/mm² (psi)

| | | | | | | | | | | |
|---|---|---|---|---|---|---|---|---|---|---|
| 1 day | 32.06 | (4650) | 31.92 | (4630) | 36.47 | (5290) | 32.82 | (4760) | 27.99 | (4060) |
| 7 days | 50.82 | (7370) | 49.64 | (7200) | 46.40 | (6730) | 49.02 | (7110) | 48.89 | (7090) |
| 28 days | 57.02 | (8270) | 57.44 | (8330) | 51.44 | (7460) | 57.44 | (8330) | 59.02 | (8560) |

TBP = tributyl phosphate

The adsorption of the polymer dispersants in each example was determined after 5 minutes and after 65 minutes. The water solution was sampled and tested to determine the initial concentration of copolymer. A small portion of the mixture was removed at 5 and 65 minutes of mixing, pressure filtered to isolate the liquid phase present, and the concentration of copolymer in the filtrate solution was determined. The results are shown in Table 1C, below. As shown in Table 1C, the subject dynamic copolymer adsorbs onto the cement particles much more slowly than the conventional polycarboxylate dispersant, regardless of what type of cement is used. The results also indicate that additional binding sites are developed over time as the moieties that protect or block the potential binding sites are hydrolyzed in the cementitious composition, extending the workability of the cementitious composition mixture.

TABLE 1C

| | | | | Polymer | |
|---|---|---|---|---|---|
| | | Dose | | Adsorption % | |
| | Dispersant | (% cmt) | Cement | 5 min | 65 min |
| Ex. 1 | Dynamic Co- | 0.280 | Essroc | 47.6 | 68.0 |
| | polymer | | Nazareth | | |
| Comp. | Conventional | 0.120 | Essroc | 94.6 | 99.9 |
| Ex. 6 | Polycarboxylate | | Nazareth | | |
| Ex. 2 | Dynamic Co- | 0.260 | Lehigh | 54.8 | 75.6 |
| | polymer | | Evansville | | |
| Comp. | Conventional | 0.120 | Lehigh | 91.8 | 100.0 |
| Ex. 7 | Polycarboxylate | | Evansville | | |
| Ex. 3 | Dynamic Co- | 0.270 | Lafarge | 45.3 | 70.2 |
| | polymer | | Whitehall | | |
| Comp. | Conventional | 0.120 | Lafarge | 97.0 | 100.0 |
| Ex. 8 | Polycarboxylate | | Whitehall | | |
| Ex. 4 | Dynamic Co- | 0.210 | Holcim I/II | 67.9 | 91.2 |
| | polymer | | | | |
| Comp. | Conventional | 0.120 | Holcim I/II | 98.1 | 100.0 |
| Ex. 9 | Polycarboxylate | | | | |
| Ex. 5 | Dynamic Co- | 0.220 | Ash Grove | 61.4 | 84.3 |
| | polymer | | TX | | |
| Comp. | Conventional | 0.120 | Ash Grove | 95.3 | 100.0 |
| Ex. 10 | Polycarboxylate | | TX | | |

### Examples 11-15

Sample high-alkali cementitious compositions were prepared by mixing cement, sand, stone and water in a rotating drum mixer, with the additives present, as shown in Table 2 below. Examples 12-15 included the subject dynamic copolymer admixture, while Comparative Example 11 included a conventional polycarboxylate dispersant. The dynamic copolymers of Examples 12, 13, 14, and 15 included residues of maleic acid and hydroxypropylacrylate, and component B and C vinyl ethers having polyethylene glycol side groups of MW 500 and 3000, 1100 and 5800, 500 and 5800, and, 1100 and 3000, respectively.

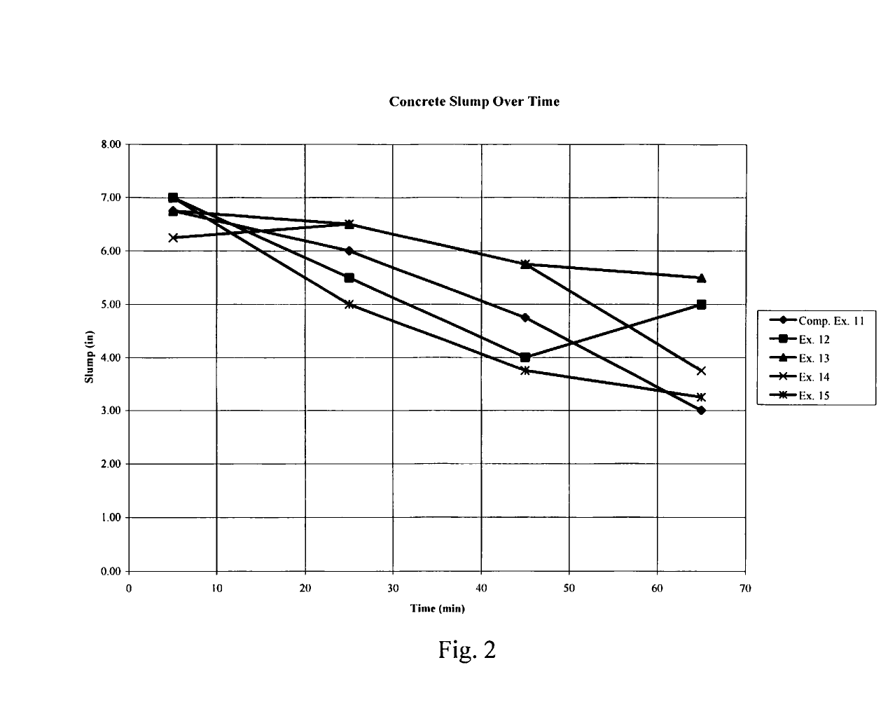

The slump, which is also a measure of workability, was determined according to ASTM C143. The air content (ASTM C231), set time (ASTM C403), and compressive strength (ASTM C39) of each composition were also determined, reported in Table 2. As shown in Table 2 and FIG. 2, the subject dynamic copolymer used in Examples 12-15 maintains the workability of the cementitious composition longer than the polymers utilized in Comparative Example 11, while not significantly affecting air content, set time, or compressive strength.

TABLE 2

| | Comp. Ex. 11 | | Ex. 12 | | Ex. 13 | | Ex. 14 | | Ex. 15 | |
|---|---|---|---|---|---|---|---|---|---|---|
| Dispersant | Conventional | | Dynamic | | Dynamic | | Dynamic | | Dynamic | |
| | Polycarboxylate | | Copolymer | | Copolymer | | Copolymer | | Polymer | |
| Dose (% cmt) | 0.118 | | 0.131 | | 0.151 | | 0.160 | | 0.127 | |
| Cement | Saylors I/II | | Saylors I/II | | Saylors I/II | | Saylors I/II | | Saylors | |
| | | | | | | | | | I/II | |
| Dose (% cmt) | 0.002 | | 0.002 | | 0.002 | | 0.002 | | 0.002 | |
| Defoamer | TBP | | TBP | | TBP | | TBP | | TBP | |
| Cement kg/m³ | 329 | (554) | 328 | (552) | 331 | (557) | 331 | (558) | 331 | (558) |
| (lbs/yd³) | | | | | | | | | | |
| Sand kg/m³ | 713 | (1201) | 710 | (1197) | 717 | (1208) | 719 | (1211) | 718 | (1210) |
| (lbs/yd³) | | | | | | | | | | |
| Stone kg/m³ | 1110 | (1871) | 1107 | (1866) | 1117 | (1883) | 1120 | (1887) | 1119 | (1885) |
| (lbs/yd³) | | | | | | | | | | |
| Water kg/m³ | 165 | (278) | 164 | (277) | 166 | (280) | 166 | (280) | 166 | (280) |
| (lbs/yd³) | | | | | | | | | | |

Slump cm (in)

| | | | | | | | | | | |
|---|---|---|---|---|---|---|---|---|---|---|
| Initial | 17.1 | (6.75) | 17.9 | (7.00) | 17.1 | (6.75) | 15.9 | (6.25) | 17.9 | (7.00) |
| 25 min. | 15.2 | (6.00) | 14.0 | (5.50) | 16.5 | (6.50) | 16.5 | (6.50) | 12.7 | (5.00) |
| 45 min. | 12.1 | (4.75) | 10.2 | (4.00) | 14.6 | (5.75) | 14.6 | (5.75) | 9.53 | (3.75) |
| 65 min. | 7.62 | (3.00) | 12.7 | (5.00) | 14.0 | (5.50) | 9.53 | (3.75) | 8.26 | (3.25) |

Air Content (%)

| | | | | | |
|---|---|---|---|---|---|
| Initial | 3.3 | 3.6 | 2.7 | 2.5 | 2.6 |
| 25 min. | 0.0 | 0.0 | 0.0 | 0.0 | 0.0 |
| 45 min. | 0.0 | 0.0 | 0.0 | 0.0 | 0.0 |
| 65 min. | 2.1 | 2.2 | 2.1 | 2.2 | 2.3 |
| Initial Set (hrs) | 5.2 | 5.7 | 5.9 | 5.4 | 5.5 |
| Final Set (hrs) | 6.8 | 7.7 | 7.3 | 7.1 | 7.3 |

Compressive Strength N/mm² (psi)

| | | | | | | | | | | |
|---|---|---|---|---|---|---|---|---|---|---|
| 1 day | 18.89 | (2740) | 18.82 | (2730) | 18.41 | (2670) | 19.44 | (2820) | 17.31 | (2510) |
| 7 days | 35.72 | (5180) | 34.54 | (5010) | 34.20 | (4960) | 34.13 | (4950) | 34.34 | (4980) |
| 28 days | 43.44 | (6300) | 38.96 | (5650) | 40.89 | (5930) | 42.06 | (6100) | 40.13 | (5820) |

TBP = tributyl phosphate

### Examples 16-21

Sample high-alkali cementitious compositions were prepared by mixing cement, sand, stone and water in a rotating drum mixer, with the additives present, as shown in Table 3 below. Examples 17-21 included the subject dynamic copolymer admixture, while Comparative Example 16 included a conventional polycarboxylate dispersant. The dynamic copolymers of Examples 17 through 21 included residues of maleic acid and hydroxypropylacrylate, and component B and C vinyl ethers having polyethylene glycol side groups of MW 1100 and 5800.

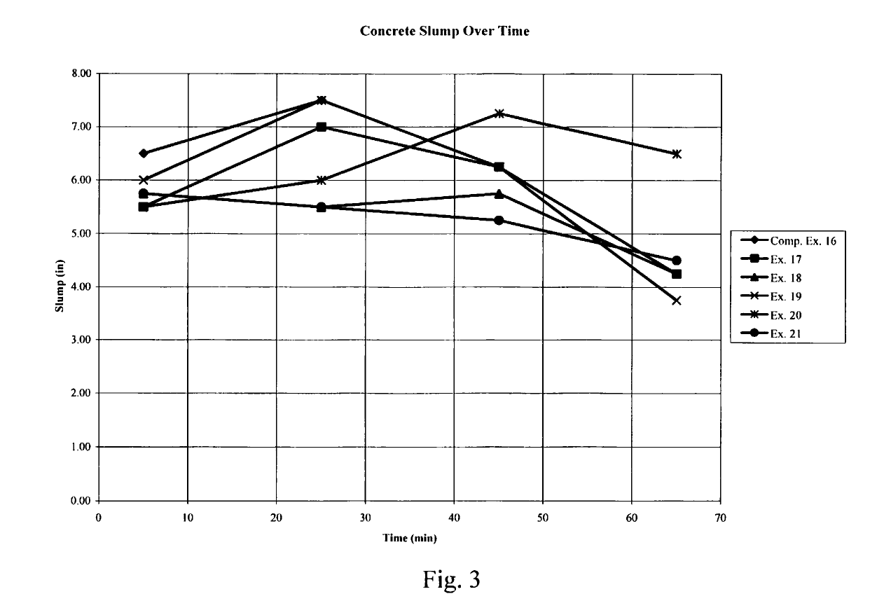

The slump, which is also a measure of workability, was determined according to ASTM C143. The air content (ASTM C231), set time (ASTM C403), and compressive strength (ASTM C39) of each composition were also determined, reported in Table 3. As shown in Table 3 and FIG. 3, the subject dynamic copolymer used in Examples 17-21 maintains the workability of the cementitious composition longer than the polymers utilized in Comparative Example 16, while not adversely affecting air content, set time, or compressive strength.

TABLE 3

| | Comp. Ex. 16 | | Ex. 17 | | Ex. 18 | | Ex. 19 | | Ex. 20 | | Ex. 21 | |
|---|---|---|---|---|---|---|---|---|---|---|---|---|
| Dispersant | Conventional | | Dynamic | | Dynamic | | Dynamic | | Dynamic | | Dynamic | |
| | Polycarboxylate | | Copolymer | | Copolymer | | Copolymer | | Copolymer | | Copolymer | |
| Dose | 0.12 | | 0.17 | | 0.15 | | 0.15 | | 0.16 | | 0.15 | |
| (% cmt) | | | | | | | | | | | | |
| Cement | Saylors I/II | | Saylors I/II | | Saylors I/II | | Saylors I/II | | Saylors I/II | | Saylors I/II | |
| Dose | 0.004 | | 0.004 | | 0.004 | | 0.004 | | 0.004 | | 0.004 | |
| (% cmt) | | | | | | | | | | | | |
| Defoamer | TBP | | TBP | | TBP | | TBP | | TBP | | TBP | |
| Cement | 332 | (560) | 332 | (559) | 331 | (558) | 331 | (558) | 332 | (559) | 332 | (559) |
| kg/m³ | | | | | | | | | | | | |
| (lbs/yd³) | | | | | | | | | | | | |
| Sand kg/m³ | 715 | (1205) | 714 | (1204) | 713 | (1202) | 713 | (1202) | 714 | (1204) | 714 | (1203) |
| (lbs/yd³) | | | | | | | | | | | | |
| Stone kg/m³ | 1123 | (1892) | 1122 | (1890) | 1120 | (1887) | 1120 | (1887) | 1122 | (1890) | 1120 | (1888) |
| (lbs/yd³) | | | | | | | | | | | | |
| Water kg/m³ | 170 | (286) | 170 | (286) | 170 | (286) | 170 | (286) | 170 | (286) | 170 | (286) |
| (lbs/yd³) | | | | | | | | | | | | |

Slump cm (in)

| | | | | | | | | | | | | |
|---|---|---|---|---|---|---|---|---|---|---|---|---|
| Initial | 16.5 | (6.50) | 14.0 | (5.50) | 14.6 | (5.75) | 14.2 | (6.00) | 14.0 | (5.50) | 14.6 | (5.75) |
| 25 min. | 19.1 | (7.50) | 17.9 | (7.00) | 14.0 | (5.50) | 19.1 | (7.50) | 15.2 | (6.00) | 14.0 | (5.50) |
| 45 min. | 15.9 | (6.25) | 15.9 | (6.25) | 14.6 | (5.75) | 15.9 | (6.25) | 18.4 | (7.25) | 13.3 | (5.25) |
| 65 min. | 10.8 | (4.25) | 10.8 | (4.25) | 10.8 | (4.25) | 9.53 | (3.75) | 16.5 | (6.50) | 11.4 | (4.50) |

Air Content (%)

| | | | | | | |
|---|---|---|---|---|---|---|
| Initial | 1.9 | 2.0 | 2.2 | 2.2 | 2.0 | 2.1 |
| 25 min. | 0.0 | 0.0 | 0.0 | 0.0 | 0.0 | 0.0 |
| 45 min. | 0.0 | 0.0 | 0.0 | 0.0 | 0.0 | 0.0 |
| 65 min. | 1.9 | 1.9 | 1.9 | 1.9 | 2.2 | 2.0 |
| Initial Set | 6.3 | 6.3 | 5.9 | 5.8 | 6.3 | 6.3 |
| (hrs) | | | | | | |
| Final Set | 7.8 | 7.7 | 7.3 | 7.5 | 7.8 | 7.9 |
| (hrs) | | | | | | |

Compressive Strength N/mm² (psi)

| | | | | | | | | | | | | |
|---|---|---|---|---|---|---|---|---|---|---|---|---|
| 1 day | 18.62 | (2700) | 19.58 | (2840) | 19.58 | (2840) | 19.86 | (2880) | 19.10 | (2770) | 19.10 | (2770) |
| 7 days | 37.51 | (5440) | 37.65 | (5460) | 35.16 | (5100) | 34.79 | (5045) | 35.16 | (5100) | 33.51 | (4860) |
| 28 days | 41.30 | (5990) | 42.96 | (6230) | 42.96 | (6230) | 43.51 | (6310) | 42.82 | (6210) | 41.58 | (6030) |

TBP = tributyl phosphate

### Examples 22-24

Sample cementitious compositions were prepared by mixing cement, sand, stone and water in a rotating drum mixer, with the additives present, as shown in Table 4 below. Examples 23 and 24 included the subject dynamic copolymer admixture, while Comparative Example 22 included a conventional polycarboxylate dispersant. The dynamic copolymers of Examples 23 and 24 included residues of maleic acid and hydroxypropylacrylate, and component B and C vinyl ethers having polyethylene glycol side groups of MW 1100 and 5800.

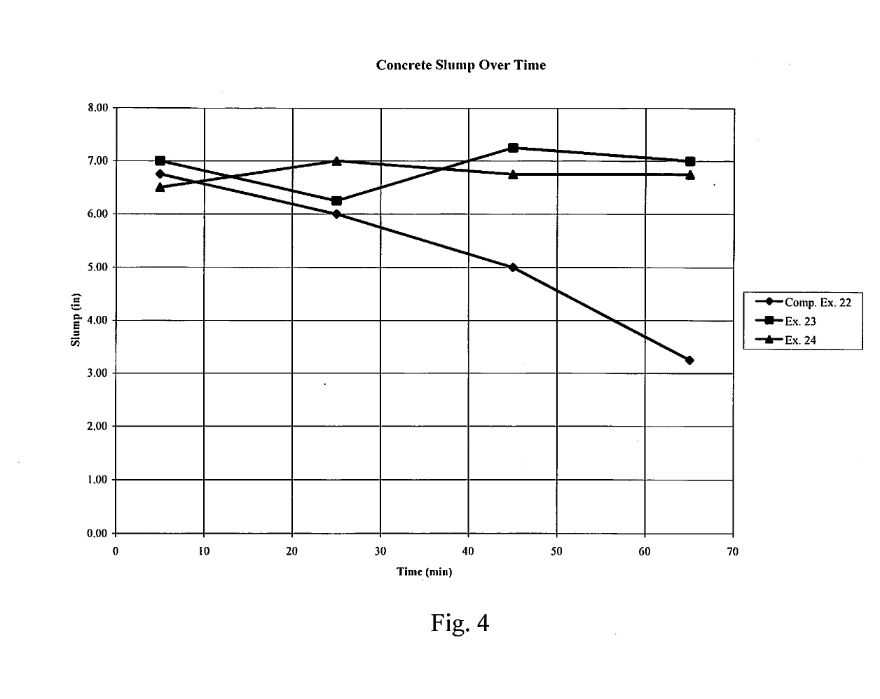

The slump, which is also a measure of workability, was determined according to ASTM C143. The air content (ASTM C231), set time (ASTM C403), and compressive strength (ASTM C39) of each composition were also determined, reported in Table 4. As shown in Table 4 and FIG. 4, the subject dynamic copolymer used in Examples 23 and 24 maintains the workability of the cementitious composition longer than the polymers utilized in Comparative Example 22, while not adversely affecting air content, set time, or compressive strength.

TABLE 4

| | Comp. Ex. 22 | | Ex. 23 | | Ex. 24 | |
|---|---|---|---|---|---|---|
| Dispersant | Conventional | | Dynamic Co- | | Dynamic | |
| | Polycarboxylate | | polymer | | Copolymer | |
| Dose (% cmt) | 0.10 | | 0.154 | | 0.130 | |
| Cement | Lafarge II | | Lafarge II | | Lafarge II | |
| Dose (% cmt) | 0.004 | | 0.004 | | 0.004 | |
| Defoamer | TBP | | TBP | | TBP | |
| Cement kg/m³ | 334 | (562) | 333 | (561) | 333 | (561) |
| (lbs/yd³) | | | | | | |
| Sand kg/m³ | 717 | (1209) | 717 | (1208) | 717 | (1208) |
| (lbs/yd³) | | | | | | |
| Stone kg/m³ | 1126 | (1898) | 1125 | (1896) | 1125 | (1896) |
| (lbs/yd³) | | | | | | |
| Water kg/m³ | 167 | (281) | 166 | (280) | 166 | (280) |
| (lbs/yd³) | | | | | | |

Slump cm (in)

| | | | | | | |
|---|---|---|---|---|---|---|
| Initial | 17.1 | (6.75) | 17.9 | (7.00) | 16.5 | (6.50) |
| 25 min. | 15.2 | (6.00) | 15.9 | (6.25) | 17.9 | (7.00) |
| 45 min. | 12.7 | (5.00) | 18.4 | (7.25) | 17.1 | (6.75) |
| 65 min. | 8.26 | (3.25) | 17.9 | (7.00) | 17.1 | (6.75) |

Air Content (%)

| | | | |
|---|---|---|---|
| 5 min. | 2.0 | 2.1 | 2.1 |
| 65 min. | 1.7 | 2.0 | 2.3 |
| Initial Set (hrs) | 4.6 | 5.0 | 4.8 |
| Final Set (hrs) | 6.0 | 6.3 | 6.2 |

Compressive Strength N/mm² (psi)

| | | | | | | |
|---|---|---|---|---|---|---|
| 1 day | 14.76 | (2140) | 16.27 | (2360) | 14.34 | (2080) |
| 7 days | 34.82 | (5050) | 35.85 | (5200) | 33.99 | (4930) |
| 28 days | 44.13 | (6400) | 44.75 | (6490) | 43.58 | (6320) |

TBP = tributyl phosphate

### Examples 25-29

Sample self compacting concrete (SCC) compositions were prepared by mixing cement, sand, stone and water in a rotating drum mixer, with the additives present, as shown in Table 2 below. Examples 26-29 included the subject dynamic copolymer admixture, while Comparative Example 25 included a conventional polycarboxylate dispersant. The dynamic copolymers of Examples 26, 27, 28 and 29 included residues of maleic acid and hydroxypropylacrylate, and component B and C vinyl ethers having polyethylene glycol side groups of MW 500 and 3000, 1100 and 5800, 500 and 5800, and, 1100 and 3000, respectively.

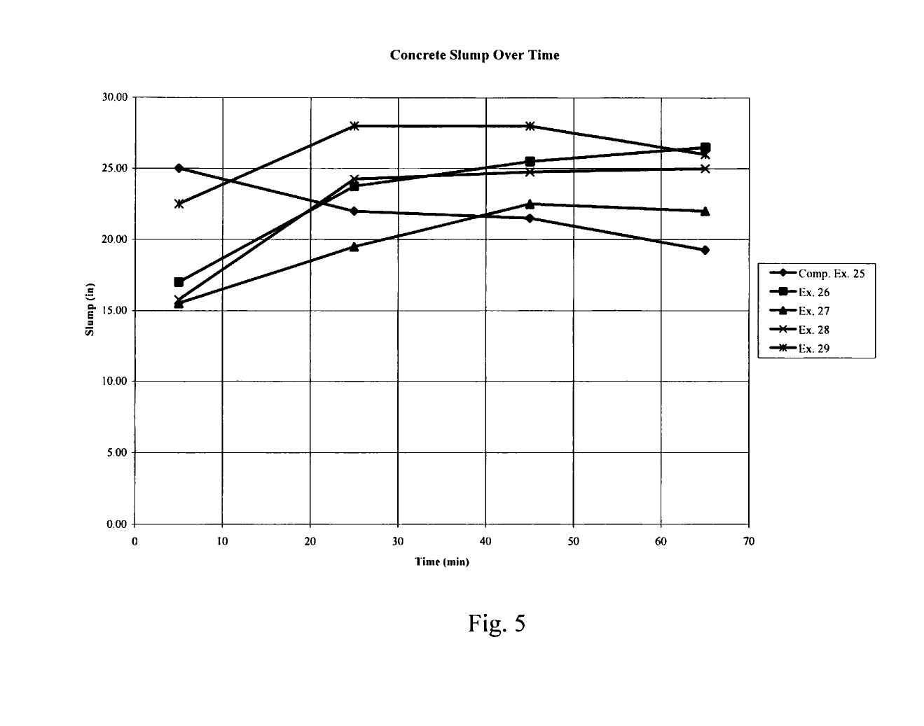

The workability of each cementitious composition, as represented by its slump flow diameter, was based upon the ASTM C143 slump test. The cone was filled with the cementitious composition at the indicated intervals, but was immediately removed and the spread of the composition was measured. The targeted slump flow of the cementitious compositions for SCC composition mix designs was 25±2 inches. The air content, set time (ASTM C403), and compressive strength (ASTM C39) of each composition were also determined, reported in Table 5. As shown in Table 5 and FIG. 5, the subject dynamic copolymer used in Examples 26-29 maintains the workability of the cementitious composition longer than the polymer utilized in Comparative Example 25, without adversely affecting air content, set time, or compressive strength.

TABLE 5

| | Comp. Ex. 25 | | Ex. 26 | | Ex. 27 | | Ex. 28 | | Ex. 29 | |
|---|---|---|---|---|---|---|---|---|---|---|
| Dispersant | Conventional | | Dynamic | | Dynamic | | Dynamic | | Dynamic | |
| | Polycarboxylate | | Copolymer | | Copolymer | | Copolymer | | Copolymer | |
| Dose (% cmt) | 0.20 | | 0.30 | | 0.30 | | 0.30 | | 0.30 | |
| Cement | Saylors I/II | | Saylors I/II | | Saylors I/II | | Saylors I/II | | Saylors I/II | |
| Dose (% cmt) | 0.008 | | 0.008 | | 0.008 | | 0.008 | | 0.008 | |
| Defoamer | TBP | | TBP | | TBP | | TBP | | TBP | |
| Dose g/kg (oz/cwt) | 3.1 | (5.0) | 3.1 | (5.0) | 3.1 | (5.0) | 3.1 | (5.0) | 3.1 | (5.0) |
| Viscosity Modifier | VMA 362 | | VMA 362 | | VMA 362 | | VMA 362 | | VMA 362 | |
| Cement kg/m³ | 404 | (681) | 399 | (672) | 395 | (666) | 398 | (670) | 402 | (677) |
| (lbs/yd³) | | | | | | | | | | |
| Sand kg/m³ | 727 | (1225) | 718 | (1210) | 711 | (1198) | 715 | (1205) | 723 | (1219) |
| (lbs/yd³) | | | | | | | | | | |
| Stone kg/m³ | 1042 | (1756) | 1030 | (1735) | 1019 | (1717) | 1025 | (1728) | 1036 | (1747) |
| (lbs/yd³) | | | | | | | | | | |
| Water kg/m³ | 178 | (301) | 177 | (298) | 174 | (294) | 176 | (296) | 178 | (300) |
| (lbs/yd³) | | | | | | | | | | |

Slump Flow Diameter cm (in)

| | | | | | | | | | | |
|---|---|---|---|---|---|---|---|---|---|---|
| Initial | 63.5 | (25.00) | 43.2 | (17.00) | 39.4 | (15.50) | 40.0 | (15.75) | 57.2 | (22.50) |
| 25 min. | 55.9 | (22.00) | 60.3 | (23.75) | 49.5 | (19.50) | 61.6 | (24.25) | 71.1 | (28.00) |
| 45 min. | 54.6 | (21.50) | 64.8 | (25.50) | 57.2 | (22.50) | 62.9 | (24.75) | 71.1 | (28.00) |
| 65 min. | 48.9 | (19.25) | 67.3 | (26.50) | 55.9 | (22.00) | 63.5 | (25.00) | 66.0 | (26.00) |

Air Content (%)

| | | | | | |
|---|---|---|---|---|---|
| Initial | 1.6 | 2.8 | 3.8 | 3.2 | 2.1 |
| 25 min. | 0.0 | 0.0 | 0.0 | 0.0 | 0.0 |
| 45 min. | 0.0 | 0.0 | 0.0 | 0.0 | 0.0 |
| 65 min. | 2.7 | 0.8 | 2.3 | 1.1 | 1.3 |
| Initial Set (hrs) | 7.5 | 10.7 | 8.2 | 9.3 | 11.4 |
| Final Set (hrs) | 9.3 | 12.3 | 10.1 | 11.0 | 12.8 |

Compressive Strength N/mm² (psi)

| | | | | | | | | | | |
|---|---|---|---|---|---|---|---|---|---|---|
| 1 day | 21.72 | (3150) | 20.55 | (2980) | 23.58 | (3420) | 21.72 | (3150) | 17.17 | (2490) |
| 7 days | 40.20 | (5830) | 40.13 | (5820) | 41.92 | (6080) | 40.34 | (5850) | 39.37 | (5710) |
| 28 days | 48.06 | (6970) | 49.58 | (7190) | 50.06 | (7260) | 48.40 | (7020) | 47.48 | (6930) |

TBP = tributyl phosphate
VMA 362 = viscosity modifying admixture

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

We claim:

1. A process for the production of slump retaining or high early strength slump retaining cementitious compositions comprising mixing hydraulic cement, aggregate, water, and a slump retention admixture, wherein the slump retention admixture comprises a dynamic polycarboxylate copolymer comprising residues of at least the following monomers,
A) an unsaturated dicarboxylic acid,
B) at least one ethylenically unsaturated alkenyl ether having a C₂₋₄ oxyalkylene chain of about 1 to 25 units,
C) at least one ethylenically unsaturated alkenyl ether having a C₂₋₄ oxyalkylene chain of 26 to about 300 units, and
D) an ethylenically unsaturated monomer comprising a moiety hydrolysable in the cementitious composition, wherein the ethylenically unsaturated monomer residue when hydrolyzed comprises an active binding site for a component of the cementitious composition.

2. The process of claim 1 wherein the dicarboxylic acid is at least one of maleic acid, fumaric acid, itaconic acid, citraconic acid, glutaconic acid, 3-methylglutaconic acid, mesaconic acid, muconic acid, traumatic acid, or salts thereof.

3. The process of claim 1 wherein at least one of the Component B or Component C ethylenically unsaturated monomers comprises a C₂₋₈ alkenyl ether group.

4. The process of claim 1 wherein at least one of the Component B or Component C alkenyl ethers comprises a vinyl, allyl or (meth)allyl ether, or is derived from a C₂₋₈ unsaturated alcohol.

5. The process of claim 4 wherein the C₂₋₈ unsaturated alcohol is at least one of vinyl alcohol, (meth)allyl alcohol, isoprenol, or methyl butenol.

6. The process of claim 1 wherein at least one of the Component B or Component C alkenyl ether side groups contains at least one C₄ oxyalkylene unit.

7. The process of claim 1 wherein the oxyalkylene comprises at least one of ethylene oxide, propylene oxide, polyethylene oxide, polypropylene oxide, or mixtures thereof.

8. The process of claim 1 wherein the hydrolysable moiety comprises at least one of a C₁₋₂₀ alkyl ester, C₁₋₂₀ amino alkyl ester, C₂₋₂₀ alcohol, C₂₋₂₀ amino alcohol, or amide.

9. The process of claim 1 wherein the ethylenically unsaturated monomer of Component D comprises at least one of alkyl acrylates, alkyl methacrylates, hydroxyalkyl acrylates, hydroxyalkyl methacrylates, maleic acid alkyl mono- or di-esters, or maleic acid hydroxyalkyl mono- or di-esters, or mixtures thereof.

10. The process of claim 1 wherein the ethylenically unsaturated monomer of Component D comprises at least one of an anhydride or imide, optionally comprising at least one of maleic anhydride or maleimide.

11. The process of claim 1 wherein the ethylenically unsaturated monomer of Component D comprises an acrylic acid ester with an ester functionality comprising the hydrolysable moiety, optionally wherein the ester functionality comprises at least one of hydroxypropyl or hydroxyethyl.

12. The process of claim 1 wherein the copolymer comprises the residues of more than one Component D ethylenically unsaturated monomer comprising a hydrolysable moiety.

13. The process of claim 12 wherein the more than one Component D ethylenically unsaturated monomer comprising a hydrolysable moiety includes the residues of:
a) more than one type of ethylenically unsaturated monomer;
b) more than one hydrolysable moiety; or
c) a combination of a) and b).

14. The process of claim 12 wherein the more than one hydrolysable moiety comprises at least one C₂₋₂₀ alcohol functionality.

15. The process of claim 1 wherein the ratio of the Component A acid monomer to the Component B plus Component C alkenyl ethers (A):(B+C) is between about 1:2 to about 2:1, optionally about 0.8:1 to about 1.5:1, and the mole ratio of (B):(C) is between about 0.95:0.05 to about 05:0.95, optionally about 0.85:0.15 to about 0.15:0.85.

16. The process of claim 1 wherein the ratio of Component A acid monomer to the Component D ethylenically unsaturated monomer comprising a hydrolysable moiety is between about 16:1 to about 1:16, optionally between about 4:1 to about 1:4, further optionally between about 3:1 to about 1:3.

17. The process of claim 1 wherein the copolymer additionally includes at least one non-hydrolysable, non-ionic ethylenically unsaturated monomer residue; or an oxyalkylene substituted monomer residue having at least one linkage of ester, amide, or mixtures thereof; or combinations thereof.

18. The process of claim 1 wherein the copolymer is represented by the following general formula I: 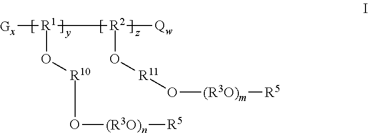
wherein R¹⁰ comprises (CₐH₂ₐ) and a is a numeral from 2 to about 8, wherein mixtures of R¹⁰ are possible in the same polymer molecule; R¹¹ comprises (C_{b}H_{2b}) and b is a numeral from 2 to about 8, wherein mixtures of R¹¹ are possible in the same polymer molecule; R¹ and R² each independently comprise at least one C₂-C₈ linear or branched alkyl; R³ comprises (CHR⁹—CHR⁹)_{c} wherein c=1 to about 3 and R⁹ comprises at least one of H, methyl, ethyl, or phenyl and wherein mixtures of R³ are possible in the same polymer molecule; each R⁵ comprises at least one of H, a C₁₋₂₀ (linear or branched, saturated or unsaturated) aliphatic hydrocarbon radical, a C₅₋₈ cycloaliphatic hydrocarbon radical, or a substituted or unsubstituted C₆₋₁₄ aryl radical; m=1 to 25, n=26 to about 300, w=about 0.1.25 to about 8, optionally about 0.5 to about 2, further optionally about 0.8 to about 1.5, x=about 0.5 to about 2, optionally about 0.8 to about 1.5, y=about 0.05 to about 0.95, optionally about 0.15 to about 0.85, and z=about 0.05 to about 0.95, optionally about 0.15 to about 0.85; y+z=1; each G is represented by at least one of: 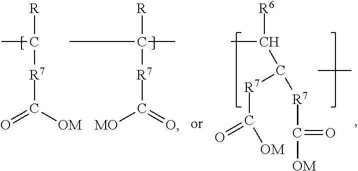
wherein each R independently comprises H or CH₃; each M independently comprises H, a monovalent metal cation such as alkali metal, or (½) divalent metal cation such as alkaline earth metal, an ammonium ion or an organic amine residue; and each R⁶ independently comprises H or C₁₋₃ alkyl; each R⁷ independently comprises a bond, a C₁₋₄ alkylene; and each Q is at least one said Component D ethylenically unsaturated monomer comprising a hydrolysable moiety.

19. The process of claim 18 wherein the Component D ethylenically unsaturated monomer comprising a hydrolysable moiety is represented by the following general formula II: 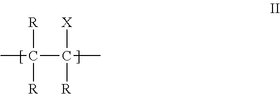
wherein each R independently comprises at least one of H or CH₃; and X comprises at least one of alkyl ester, hydroxyalkyl ester, alkyl amino ester, amino hydroxyalkyl ester, or amide, optionally at least one of acrylamide, methacrylamide or derivatives thereof.

20. The process of claim 18 wherein the ethylenically unsaturated monomer comprising a hydrolysable moiety is represented by the following general formula III: 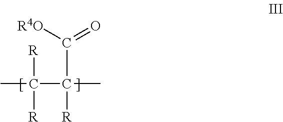
wherein each R independently comprises at least one of H or CH₃; and R⁴ comprises at least one of C₁₋₂₀ alkyl or C₂₋₂₀ hydroxyalkyl.

21. The process of claim 18 wherein the substituted aryl radical comprises at least one of —CN, —COOR⁸, —R⁸, —OR⁸, hydroxyl, carboxyl or sulfonic acid groups, wherein R⁸ is hydrogen or a C₁₋₂₀ aliphatic hydrocarbon radical.

22. The process of claim 19 wherein the amide is represented by —NH—R⁵, wherein R⁵ comprises at least one of H, a C₁₋₂₀ (linear or branched, saturated or unsaturated) aliphatic hydrocarbon radical, a C₅₋₈ cycloaliphatic hydrocarbon radical, or a substituted or unsubstituted C₆₋₁₄ aryl radical; optionally wherein the substituted aryl radical comprises at least one of —CN, —COOR⁸, —R⁸, —OR⁸, hydroxyl, carboxyl or sulfonic acid groups, wherein R⁸ is hydrogen or a C₁₋₂₀ aliphatic hydrocarbon radical.

23. The process of claim 1 wherein the cementitious composition additionally comprises a conventional polycarboxylate copolymer.

24. The process of claim 1 wherein the cementitious composition comprises a precast cementitious composition, the process further including forming a cast in place or precast cementitious member from the mixture.

25. The process of claim 1 wherein the cementitious composition comprises a ready mix cementitious composition.

26. The process of claim 1 wherein the cementitious composition comprises a highly filled cementitious composition, including at least 10 weight percent of at least one of pozzolans, finely divided mineral fillers, inert fillers, or mixtures thereof.

27. The process of claim 1 comprising adding to the cementitious mixture an additional water reducing composition as a component of the admixture or separately.

28. The process of claim 27, wherein the water reducing composition comprises at least one of traditional water reducers, conventional polycarboxylate dispersants, polyaspartate dispersants, or oligomeric dispersants.

29. The process of claim 28, wherein the traditional water reducer comprises at least one of lignosulfonates, melamine sulfonate resins, sulfonated melamine formaldehyde condensates, or salts of sulfonated melamine sulfonate condensates.

30. The process of claim 1 including introducing an additional admixture or additive of at least one of air entrainers, aggregates, pozzolans, fillers, set accelerators/enhancers, strength accelerators/enhancers, set retarders, corrosion inhibitors, wetting agents, water soluble polymers, rheology modifying agents, water repellents, fibers, damp-proofing admixtures, permeability reducers, pumping aids, fungicidal admixtures, germicidal admixtures, insecticide admixtures, finely divided mineral admixtures, alkali-reactivity reducers, colorants, bonding admixtures, shrinkage reducing admixtures, or mixtures thereof.
